(19) United States
(12) Patent Application Publication
(10) Pub. No.: US 2023/0334078 A1
(43) Pub. Date: Oct. 19, 2023

(54) CONTEXTUAL GROUPING OF HANDWRITTEN NOTES TO A PORTABLE INFORMATION HANDLING SYSTEM

(71) Applicant: Dell Products L.P., Round Rock, TX (US)

(72) Inventors: Benedict Tiong Chee Tay, Singapore (SG); Tung Dao, Singapore (SG); Patlapa Davivongsa, Singapore (SG)

(73) Assignee: Dell Products L.P., Round Rock, TX (US)

(21) Appl. No.: 17/723,878

(22) Filed: Apr. 19, 2022

(51) Int. Cl. G06F 16/35

(52) U.S. Cl. CPC G06F 16/355

(57) ABSTRACT

A tablet information handling system accepts handwritten inputs by a stylus to a touchscreen display and manages the handwritten notes with a notes application that includes cluster analysis of note content and a context for how the note was taken, such as time and location, to sort the notes by topics. A soft cluster analysis based upon vocabulary generated with cross unification of user-generated content and system-generated content orders handwritten notes in topics having related soft clusters by relevance to provide an end user with improved access and usability of handwritten notes, including automated management, such as scheduling functions.

### BACKGROUND OF THE INVENTION

### Field of the Invention

The present invention relates in general to the field of portable information handling systems, and more particularly to contextual grouping of handwritten notes to a portable information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems integrate processing components, a display and a power source in a portable housing to support mobile operations. Portable information handling systems allow end users to carry a system between meetings, during travel, and between home and office locations so that an end user has access to processing capabilities while mobile. Tablet configurations typically expose a touchscreen display on a planar housing that both outputs information as visual images and accepts inputs as touches. Convertible configurations typically include multiple separate housing portions that couple to each other so that the system converts between closed and open positions. For example, a main housing portion integrates processing components and a keyboard and rotationally couples with hinges to a lid housing portion that integrates a display. In clamshell configuration, the lid housing portion rotates approximately ninety degrees to a raised position above the main housing portion so that an end user can type inputs while viewing the display. Some convertible systems convert to a tablet position, such as by rotating the housing 360 degrees, so that an end user can perform touch inputs at a touchscreen of the display. After usage, convertible information handling systems rotate the lid housing portion over the main housing portion to protect the keyboard and display, thus reducing the system footprint for improved storage and mobility.

One advantage of portable information handling systems that include a touchscreen is that end users can write notes to the touchscreen rather than use a keyboard. In particular, end users often handwrite notes to a tablet information handling system touchscreen much as they might write to a notebook. Logic executing on the tablet information handling system recognizes handwritten letters to translate the notes to digital content that can be stored and manipulated with word processing and other applications. Generally, handwritten notes are stored both as visual images and digital content by a note taking application, such as in a dashboard that the end user accesses to retrieve the handwritten notes. One difficulty with this approach is that handwritten notes tend to have a wide variety of content written during a hurry or in a pause of other events. For example, handwritten notes might include work tasks like scheduling meetings, home tasks like grocery lists and extraneous thoughts like a poem. As a tablet information handling system notes dashboard populates, the end user generally must spend time organizing the notes and taking actions in the notes, otherwise the dashboard can become too crowded to be useful. Generally, manually organizing notes can be a big task and involve a variety of interactions at different computers and applications, such as a calendar, a phonebook, a word processing application, a photo library, etc.... In some instances, confusion regarding the contents of written notes and difficulty organizing them can defeat the purpose of a notes application to simplify tablet information handling system interactions.

### SUMMARY OF THE INVENTION

Therefore, a need has arisen for a system and method which manages handwritten notes made at an information handling system.

In accordance with the present invention, a system and method are provided which substantially reduce the disadvantages and problems associated with previous methods and systems for managing handwritten notes input at a tablet information handling system. Cross unification of user generated information and system generated information are applied to define a vocabulary that is used to perform cluster analysis on handwritten notes. The cluster analysis sorts handwritten notes by topic in an order of relevance so that a feature comparison of new handwritten notes provide efficient association with existing clusters using the vocabulary.

More specifically, a tablet information handling system accepts and saves handwritten notes made to a touchscreen display by a stylus and organizes the handwritten notes by a cluster analysis of a vocabulary cross unified by user generated information and system generated information, such as physical location, time of day and participants involved in a meeting at which the handwritten notes were taken. A notes application defines clusters sorted by topics using a vocabulary selected from the user and system generated information so that soft clusters of handwritten notes relate by relevant topics in an ordered list of matches to the cluster definitions. The note application allows the end user to search for written notes by content, the physical location at which the notes were taken, the time of day that the notes were taken, collaborators in a meeting at which the notes were taken or other relevant factors isolated through the cluster training process. New handwritten notes infer a cluster relationship through a feature comparison of vocabulary shared with clusters defined in the cluster analysis.

The present invention provides a number of important technical advantages. One example of an important technical advantage is that handwritten notes are quickly and efficiently organized into topics based on a cluster analysis of vocabulary derived from user generated information and system generated information. An end user is provided with a rapid organization of handwritten notes to review and apply in a practical manner, such as for scheduling events like recurring meetings and tracking discussions at the recurring meetings. A variety of different views of relationships across handwritten notes, such as by including notes in multiple soft clusters defined by time, location and meeting participants, enables an end user to put the handwritten information to use in an efficient manner with a decluttered dashboard.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an example environment in which handwritten note taking is supported by a tablet information handling system;

FIG. 2 depicts an exploded view of a tablet information handling system configured to execute a notes application that manages organization of handwritten notes;

FIG. 3 depicts a flow diagram of a process and logical elements for training a notes application that manages handwritten notes;

FIG. 4 depicts a system block diagram of logical elements that cooperate to manage handwritten notes taken at a tablet information handling system; and

FIG. 5 depicts a flow diagram of a process for managing handwritten notes made at a tablet information handling system.

### DETAILED DESCRIPTION

Handwritten notes taken at a tablet information handling system are managed by reference to a vocabulary cross unified by user-generated information and system-generated information. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

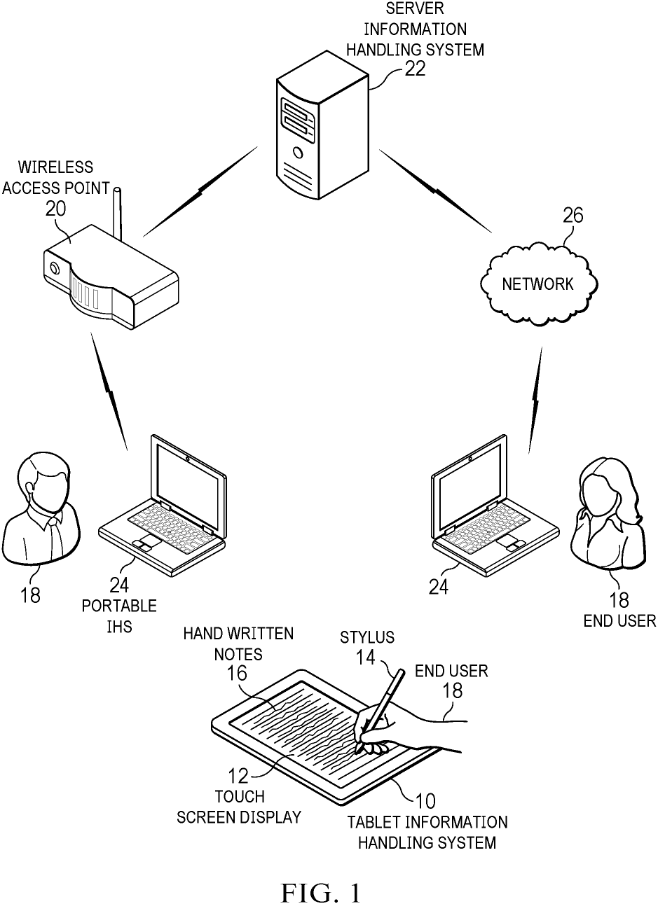

Referring now to FIG. 1, an example environment is depicted in which handwritten note taking is supported by a tablet information handling system 10. In the example embodiment, an end user 18 hand writes notes to a touchscreen 12 integrated in tablet information handling system 10 with a stylus 14. Stylus 14 mimics a pen that end user 18 applies as a conventional writing instrument to trace out handwritten notes 16 as if writing on paper of a notebook. A notes application executing on tablet information handling system 10 mimics conventional notes taking to a notebook by storing the handwritten notes 16 as an image that the end user can review at a later time, however, processing capability of tablet information handling system can be applied to further enhance the handwritten notes 16. First, tablet information handling system 10 processes the image to extract user-generated information, such as by digitizing and saving the note content so that the notes application can analyze the content for use with other applications, such as scheduling and word processing. Second, tablet information handling system 10 processes system-generated information based upon the context at tablet information handling system 10 when the note was handwritten and when the note is reviewed by the end user. In the example embodiment, at the time that handwritten notes 16 are taken, the end user is meeting, either virtually or in person, with other end users 18 who are interacting with portable information handling systems 24. Tablet information handling 10 communicates through a wireless access point 20 and server information handling system 22 with a network 26 that each provides system-generated information related to handwritten notes 16. For example, system generated information may include a time of day of the note taking or note reading activity, the identity of other end users present at the note taking or note reading activity, the location of the note taking or note reading activity as indicated by the network identify or a GPS location, other information sources reviewed during note taking or note reading activity and information files exchanged with other users, such as documents and presentations.

A notes application executing on tablet information handling system 10 manages handwritten notes 16 stored by end user 18 through selective formation of a vocabulary with a cross unification of user generated information and system generated information. Handwritten notes 16 stored by an end user are analyzed in a training stage to select a vocabulary that relates user generated and system generated content and defines soft clusters that each sorts handwritten notes in an order of relevance for the cluster. Soft clusters mean that a handwritten note might be placed in plural clusters based upon the vocabulary of the handwritten note and with a different level of relevance in each cluster. As an example, handwritten notes may be related to a regularly scheduled meeting based upon time, location and participants, and may also be related to a project covered at the meeting based upon documents referenced during the meeting. Cross unification of user generated information and system generated information may generate a vocabulary with a prominent word selected as a topic based upon the timing of the meeting and the various contents addressed in the meeting. A dashboard of the notes application presents the handwritten note by topic and automatically relates the handwritten note to other actions, such as scheduling another meeting or saving a digital copy of the content in a folder related to the project. Once clusters are defined and given a topic based upon vocabulary determined through training, subsequent handwritten notes may be applied to the vocabulary to infer topic assignments for placement of the handwritten notes in clusters. As an example, clusters may include topics for recurring meetings, physical location, title similarities and shared users.

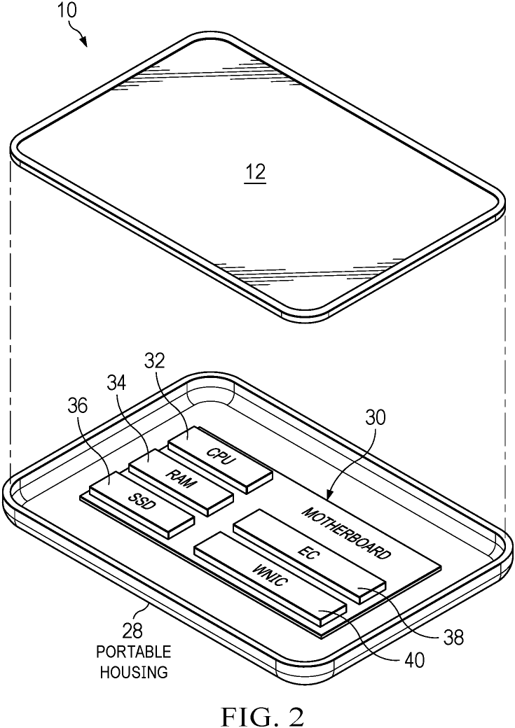

Referring now to FIG. 2, an exploded view depicts a tablet information handling system 10 configured to execute a notes application that manages organization of handwritten notes. In the example embodiment, a portable housing 28 has a touchscreen display coupled over processing components that cooperate to process information. A motherboard 30 couples to portable housing 28 and supports communication between the processing components through integrated wirelines. A central processing unit (CPU) 32 executes instructions that process information, such as an operating system and a notes application that manages handwritten notes. A random access memory (RAM) 34 stores instructions and information for access by CPU 32. A solid state drive (SSD) 36 provides a non-transitory storage device that stores instructions and information with persistent memory, such as flash memory. For example, at power on of the system CPU 32 retrieves an operating system to RAM 34 from SSD 36 for execution, and runs a notes application over the operating system to manage handwritten notes made at touchscreen display 12. An embedded controller 38 coordinates interactions of physical devices, such as for application of power and maintenance of thermal constraints, and supports interactions with input/output (I/O) devices, such as a keyboard, mouse and touches detected by a touch controller of touchscreen display 12. A wireless network interface controller (WNIC) 40 supports network communication through a wireless signal, such as with a wireless access point. The notes application coordinates acceptance through touchscreen display 12 for storage in SSD 36 based upon analysis of a vocabulary trained from user and system generated information and used to infer cluster relationships, as set forth in greater detail by the example embodiment below.

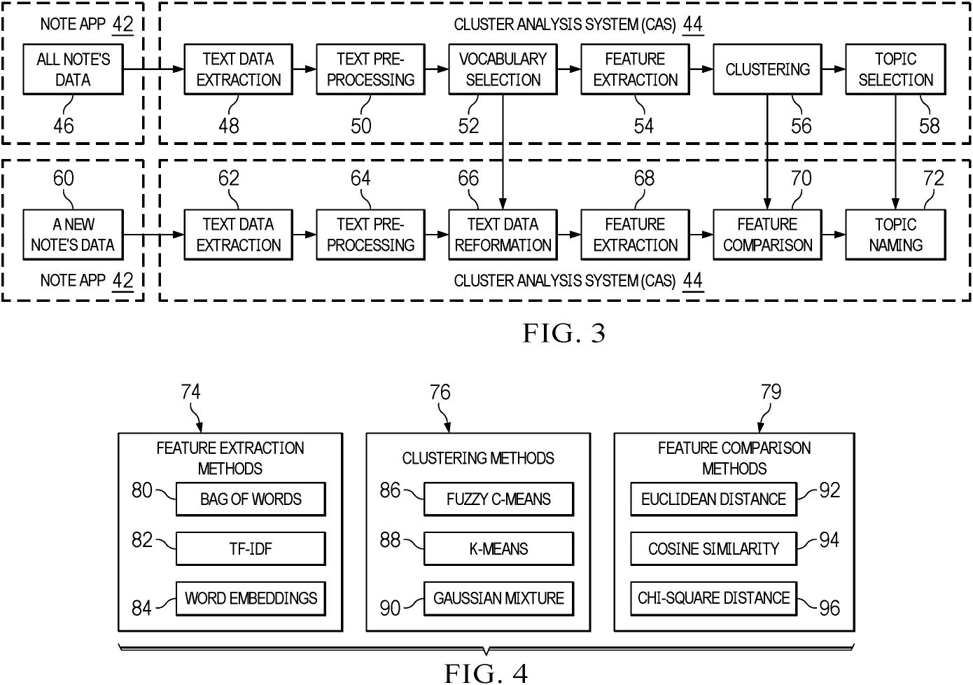

Referring now to FIG. 3, a flow diagram depicts a process and logical elements for training a notes application that manages handwritten notes. For example, note application 42 has instructions that execute a first cluster analysis system 44 to train for management of handwritten notes based upon a collection of all notes data 46 having all handwritten notes taken by the tablet information handling system. A second cluster analysis system 44 applies the training to new notes data 60 having a new handwritten note accepted at the touchscreen display to infer the placement of the new handwritten notes to clusters. The training cluster analysis system and inference cluster analysis system follow similar logic as represented by the instruction modules that execute each process step. At an initial text data extraction step 48 and 62 the process extracts information from the end user’s handwritten note including user generated data, such as words or other content included in the handwritten note, and system generated data, such as a time of day, meetings scheduled in a calendar application, location, other user’s in contact with the system and documents referenced during the creation of the handwritten note. The user generated and system generated information is applied in text preprocessing step 50 and 64 with a sequence of logical modules that perform tokenization, transformation, normalization and filtering of the user generated and system generated information. The text preprocessing removes noise and exposes hidden information between stop words and sparse representations in the text data. The preprocessing prepares text of content in the handwritten note for selection of vocabulary and application of cluster analysis.

Once the content of the handwritten note is prepared for analysis, the process continues to vocabulary selection at step 52. As vocabulary is identified in the training cluster analysis system at step 52, the vocabulary is added to the inference cluster analysis system for use by a text data reformation step 66. Vocabulary selection at step 52 splits the information into different categories, such as title, location, timing, contents, etc... The representation of words in the categories carries different semantic values based upon the context that the words appear in. Vocabulary selection 52 selects the top important words of each category and combines these words to form a vocabulary that is applied by cluster analysis to new handwritten notes made by the end user at step 66 by reforming the new handwritten notes. At steps 54 and 68 feature extraction is performed with the vocabulary words found in the handwritten note that maps each word of the vocabulary onto an n-dimensional vector space. The mapping transforms text information into numerical data to which cluster analysis is applied at step 56 and feature comparison is applied at step 70. At step 56 cluster analysis performed to associated vocabulary across the handwritten note data and relate vocabulary to clusters. In the example embodiment, a soft cluster analysis is used that assigns times to multiple soft cluster groups. These defined clusters are used at step 70 by comparing extracted features with cluster features to assign handwritten notes to clusters. At step 58 cluster topics are selected from the vocabulary found in each cluster, such as by identifying a prominent vocabulary word that is understandable to an end user. At step 72, the topic name for a new handwritten note is identified from the cluster that it is related to, such as by association with vocabulary word in the topic name for the most relevant cluster. Once a new handwritten note is assigned to a cluster, the note application can query other relevant notes for retrieval and presentation to the end user.

Referring now to FIG. 4, a system block diagram depicts logical elements that cooperate to manage handwritten notes taken at a tablet information handling system. Feature extraction methods 74 are applied at steps 54 and 68 to extract features from content based upon the vocabulary. In the example embodiment, a bag-of-words method 80, TF-IDF method 82 and word embedding method 84 are used. Clustering methods 76 are used to perform cluster analysis at step 56 including fuzzy C-means logic 86, K-means logic 88 and Gaussian mixture logic 90. Feature comparison methods 78 perform feature comparison at step 79 and include Euclidean distance logic 92, cosine similarity logic 94 and Chi-square distance logic 96. In alternative embodiments, other types of logic may be used for feature extraction, clustering and feature comparison.

In one example Use Case 1 embodiment, the notes application works with a scheduling application to manage recurring meetings and handwritten notes generated in the recurring meetings. For instance, an end user establishes a weekly recurring meeting for a “Project X” with a team of predetermined individuals. The note application issues a reminder at the meeting start time and provides a user interface to create a meeting note associated with the meeting. The meeting note is auto populated with the meeting name and related tags from the schedule and the user is prompted to define the meeting as a recurring meeting if appropriate so that future handwritten notes will cluster with this note. If the handwritten note is indicated as recurring, then future notes from the recurring meeting will cluster while other related factors, such as participants in the meeting, are used to define other soft clusters that are related with less relevance to the handwritten notes.

In another example Use Case 2 embodiment, the notes application works with a location sensor, such as a GPS sensor or WNIC 40 that identifies network locations, to tie handwritten notes to a location. For instance, an end user travels to different locations to hold meetings. At a location when the note application opens and detects the location, the end user is prompted to inquire if notes for the location should be related to a topic named for the location. If the end user selects location association and takes notes, the notes are clustered with the location, such as under a topic named for the location. The other information for the content may be applied to soft cluster with other handwritten notes.

In another example Use Case 3 embodiment, the notes application tracks content over time to relate handwritten notes by a cluster with a topic title. For instance, an end user has several projects at work and includes a title on the notes with project name. The notes application picks up the commonality in the title name and inquires if all notes for the title should be kept as a project. If the end user selects yes, the notes are organized in a common folder using the title and associated by soft clusters with other notes as appropriate.

In another example Use Case 4 embodiment, the notes application tracks notes based upon collaboration with other end users at the time the notes are taken. For instance, an end user works closely with two other individuals on several projects and shares notes during collaboration. The notes application detects the presence of the two other individuals during notetaking, such as by the exchange of documents or of the notes. The end user is queried whether to relate collaborative notes with the two individuals as a cluster. If the end user selects yes, then previous collaborative notes and future collaborations are stored as a project or file.

In another example Use Case 5 embodiment, the notes application performs an analysis of handwritten notes to provide organization to an end user. After an extended time period of using notes, an end user may have difficulty sorting through the notes to ensure that all of the information is properly saved and accessible. The end user can initiate a cluster analysis that sorts and organizes the handwritten notes to provide a list of topics and files based upon triangulation of meeting titles, recurrence, time of meetings, physical location and collaborators in the meetings, as well as content of the notes analyzed as text and images. The end user may be presented with the handwritten notes with titles applied to soft clusters so that actions on the notes are more readily performed. In one example Use Case 6 embodiment, as an end user takes notes the end user might recall previous related meetings. The end user requests that the notes application find similar handwritten notes resulting in suggestions provided based upon a cluster feature comparison. For instance, the similar notes are based upon a proximity index of the information triangulating from meeting titles, recurrence, time, location, collaborators and content tags of shared vocabulary.

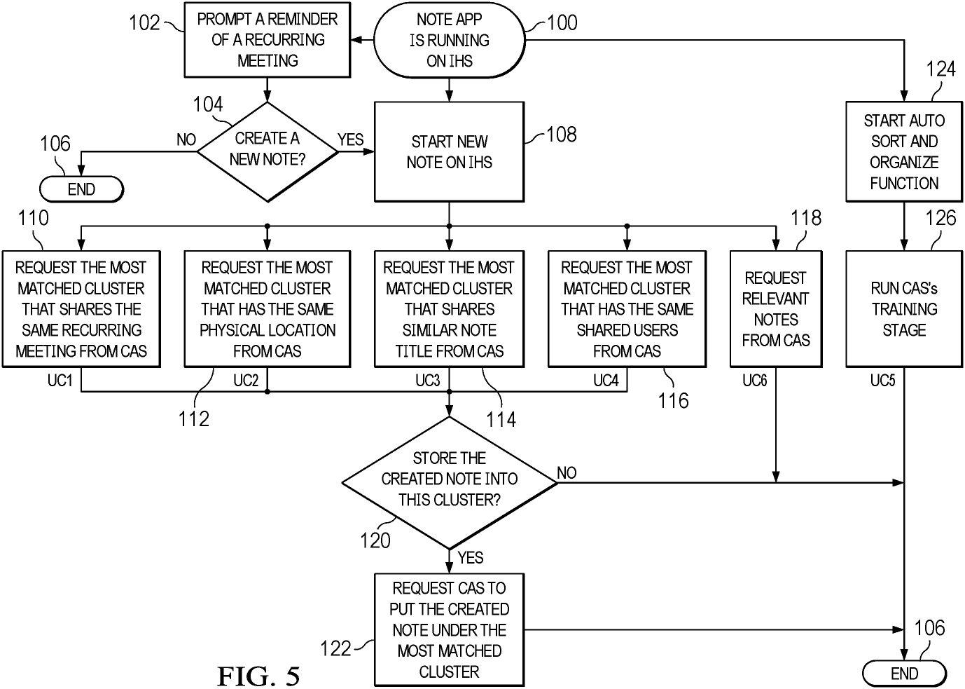

Referring now to FIG. 5, a flow diagram depicts a process for managing handwritten notes made at a tablet information handling system by reference to the above example Use Cases 1-6. The process starts at step 100 with the note application executing on the tablet information handling system. At step 102 a prompt reminds the end user of a recurring meeting. At step 104 if the end user does not create a new note the process ends at step 106. If at step 104 the end user creates a new note, the process continues to step 108 to start a new note on the information handling system. For step 108, the process continues to step 110 for use case 1 by requesting the most matched cluster that shares the same recurring meeting. From step 108 the process also continues to step 112 for use case 2 to request the most matched cluster that has the same physical location. From step 108 the process continues to step 114 for use case 3 to request the most matched cluster that shares similar note title to the new note. From step 108 for use case 4 the process continues to step 116 to request the most matched cluster that has the same shared users as the new note. At step 120 a determination is made whether the new note is stored with the cluster identified by the match requested by the end user. If so, the process continues to step 122 to request that the created note be associated with the match as indicated by the end user. If at step 120 the end user elects not to store the note to the identified cluster, the process ends at step 106. At step 108, the end user may initiate a cluster analysis and match for use case 6 at step 118 to request the most relevant notes based upon the clusters analysis and matches and the process ends at step 106. From step 100, when the end user seeks a fresh analysis of related notes, the process continues to step 124 to start an automated sort and organize function of existing notes. At step 126 the training process is executed for use case 5 and the results are presented to the end user, and the process ends at step 106.

Although the present invention has been described in detail, it should be understood that various changes, substitutions and alterations can be made hereto without departing from the spirit and scope of the invention as defined by the appended claims.

What is claimed is:

1. A portable information handling system comprising:
a planar housing;
a processor disposed in the planar housing and operable to execute instructions that process information;
a memory disposed in the planar housing and interfaced with the processor to store the instructions and information;
a storage device interfaced with the processor and memory, the storage device having a non-transitory memory operable to store the instructions and information;
a touchscreen display coupled to the planar housing and interfaced with the processor and memory, the touchscreen display operable to accept end user inputs as touches, the end user inputs including handwritten notes; and
a notes application stored in the non-transitory memory of the storage device that when executed on the processor causes:
storage of plural handwritten notes input at the touchscreen display;
training of a vocabulary to relate the plural handwritten notes to one or more of plural clusters by cross-unification of user generated content of the plural handwritten notes and system-generated content associated with each of the plural handwritten notes; and
sorting of each of the plural handwritten notes into one or more of plural clusters based upon the vocabulary of each of the plural handwritten notes.

2. The portable information handling system of claim 1 wherein the training further comprises:
cluster analysis to define plural clusters, each cluster having a topic; and
assigning each of the plural handwritten notes to one or more of the plural clusters in an order of relevance based upon the vocabulary of each of the plural handwritten notes.

3. The portable information handling system of claim 2 wherein the training further comprises:
mapping each word of the vocabulary to an n-dimensional vector space; and
applying numerical analysis to the n-dimensional vector space.

4. The portable information handling system of claim 2 wherein the training further comprises:
defining plural vocabulary categories including at least note title, note location, note time and note content; and
applying a different semantic value to each of the vocabulary based upon the vocabulary category in which the vocabulary is found.

5. The portable information handling system of claim 4 wherein the training further comprises naming each of the plural clusters from a vocabulary taken from each of the plural clusters.

6. The portable information handling system of claim 5 wherein the plural clusters include at least a recurring meeting cluster, a physical location cluster, a title similarity cluster and a shared user cluster.

7. The portable information handling system of claim 6 wherein the system-generated content includes at least a physical location of the information handling system at generation of each of the plural handwritten notes.

8. The portable information handling system of claim 1 wherein the sorting further comprises:
sorting the handwritten notes as soft clusters, each handwritten note sorted to plural cluster topics defined by the training; and
ordering handwritten notes in each cluster topic based upon vocabulary relevance.

9. The portable information handling system of claim 8 wherein the sorting further comprises:
sorting at least some of the handwritten notes as calendar events; and
populating a calendar entry for each calendar event to present to the end user.

10. The portable information handling system of claim 9 wherein the calendar events include a handwritten note location sensed by the information handling system.

11. A method for managing handwritten notes input at an information handling system touchscreen display, the method comprising:
storing plural handwritten notes input at the touchscreen display to memory of the information handling system;
training of a vocabulary to relate the plural handwritten notes to one or more of plural clusters by cross-unification of user generated content of the plural handwritten notes and system-generated content associated with each of the plural handwritten notes; and
sorting of each of the plural handwritten notes into one or more of plural clusters based upon the vocabulary of each of the plural handwritten notes.

12. The method of claim 11 wherein the training further comprises:
performing cluster analysis to define plural clusters, each cluster having a topic; and
assigning each of the plural handwritten notes to one or more of the plural clusters in an order of relevance based upon the vocabulary of each of the plural handwritten notes.

13. The method of claim 12 wherein the training further comprises:
mapping each word of the vocabulary to an n-dimensional vector space; and
applying numerical analysis to the n-dimensional vector space.

14. The method of claim 13 wherein the training further comprises:
defining plural vocabulary categories including at least note title, note location, note time and note content; and
applying a different semantic value to each of the vocabulary based upon the vocabulary category in which the vocabulary is found.

15. The method of claim 14 wherein the training further comprises naming each of the plural clusters from a vocabulary taken from each of the plural clusters.

16. The method of claim 15 wherein the plural clusters include at least a recurring meeting cluster, a physical location cluster, a title similarity cluster and a shared user cluster.

17. The method of claim 16 wherein the system-generated content includes at least a physical location of the information handling system at generation of each of the plural handwritten notes.

18. The method of claim 11 wherein the sorting further comprises:
sorting the handwritten notes as soft clusters, each handwritten note sorted to plural cluster topics defined by the training; and
ordering handwritten notes in each cluster topic based upon vocabulary relevance.

19. The method of claim 18 wherein the sorting further comprises:
sorting at least some of the handwritten notes as calendar events; and
populating a calendar entry for each calendar event to present to the end user.

20. The method of claim 19 wherein the calendar events include a handwritten note location sensed by the information handling system.
